(19) United States
(12) Patent Application Publication
(10) Pub. No.: US 2014/0119542 A1
(43) Pub. Date: May 1, 2014

(54) INFORMATION PROCESSING DEVICE, INFORMATION PROCESSING METHOD, AND INFORMATION PROCESSING PROGRAM PRODUCT

(71) Applicant: KABUSHIKI KAISHA TOSHIBA, Tokyo (JP)

(72) Inventor: Jun SATO, Tokyo (JP)

(21) Appl. No.: 13/907,396

(22) Filed: May 31, 2013

(30) Foreign Application Priority Data
Oct. 31, 2012 (JP) 2012-241108

(51) Int. Cl. H04N 7/167

(52) U.S. Cl. CPC H04N 7/167
USPC 380/200

(57) ABSTRACT

According to one embodiment, an information processing control method includes: receiving encrypted main video data obtained by encrypting main video data obtained by down-converting video data corresponding to an initial resolution of a content and encrypted sub video data obtained by encrypting sub video data as a difference between high-resolution video data obtained by up-converting the main video data and the video data corresponding to the initial resolution; acquiring a first encryption key corresponding to the encrypted sub video data; generating a second encryption key corresponding to the encrypted main video data from the first encryption key by using a one-way function; decoding the encrypted sub video data by using the first encryption key and decode the encrypted main video data by using the second encryption key generated; and processing each of the main video data and the sub video data obtained by decoding to generate the video data.

### CROSS-REFERENCE TO RELATED APPLICATIONS

This application is based upon and claims the benefit of priority from Japanese Patent Application No. 2012-241108, filed Oct. 31, 2012, the entire contents of which are incorporated herein by reference.

### FIELD

Embodiments described herein relate generally to an information processing device, an information processing method, and an information processing program product.

### BACKGROUND

Conventionally, for transmitting a plurality of transport streams to transmit a moving image, disclosed has been a method of multiplexing the transport streams to transmit them in a single transmission path (see, Japanese Patent Application Laid-open No. 11-41193).

In recent years, a differential transmission method has been developed to distribute contents of 8K4K (7680 pixels (dots)×4320 pixels (dots)) and 4K2K (4096 pixels×2160 pixels), for lack of infrastructures for broadband communication and broadcasting systems that can exclusively use a band of a bit rate necessary for transmitting the contents.

The differential transmission method is a method of transmitting, for example, a 4K2K content in a divided manner into a main stream and a sub stream. The main stream is obtained by down-converting the 4K2K content to a 2K1K (1920 pixels×1080 pixels) content and coding it with H.264 or MPEG-2. The sub stream is obtained as the 4K differential signal by up-converting the 2K1K content to a 4K2K content and coding a difference between the obtained 4K2K content and the original 4K2K content with High Efficiency Video Coding (HEVC). The 2K1K content coded with H.264 is broadcast as broadcasting waves or IPTV broadcast, for example, and the differential signal is distributed through the Internet in a file format or the like. Each stream is multiplexed in an MPEG-2 transport stream (TS) format and transmitted.

The main stream (2K1K content) and the sub stream (difference) are received by a receiver via a single path or different paths, and decoded and synthesized so as to be reproduced as a 4K2K content.

When the 4K2K content reproduced on the receiver is recorded in a recording device such as a hard disk device, the 4K2K content is recorded by encoding, encrypted, and stored therein as a file.

When both the 4K2K content and the 2K1K content are recorded in the recording device, recorded volume increases because they are separate contents.

Furthermore, when recorded in the recording device, the contents are re-encrypted. This leads to generation of a new encryption key for each of the contents for a security reason. Accordingly, the encryption keys for the contents are mutually independent, resulting in lower usability.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary schematic configuration block diagram illustrating a content distribution system according to an embodiment;

FIG. 2 is an exemplary schematic configuration block diagram illustrating a content distribution device in the embodiment;

FIG. 3 is an exemplary schematic configuration block diagram illustrating a digital television device in the embodiment;

FIG. 4 is an exemplary schematic functional configuration block diagram illustrating a processor and a signal processor according to a first embodiment; and

FIG. 5 is an exemplary schematic functional configuration block diagram illustrating a processor and a signal processor according to a second embodiment.

### DETAILED DESCRIPTION

In general, according to one embodiment, An information processing device comprises: an input module configured to receive encrypted main video data comprising down-converted video data of video data corresponding to an initial resolution of a content, and to receive encrypted sub video data comprising difference data between high-resolution video data obtained by up-converting the main video data and the video data corresponding to the initial resolution; a key acquisition module configured to acquire a first encryption key corresponding to the encrypted sub video data; a key generator configured to generate a second encryption key corresponding to the encrypted main video data from the first encryption key by using a one-way function; a decoder configured to decode the encrypted sub video data by using the first encryption key and to decode the encrypted main video data by using the second encryption key; and an initial resolution video generator configured to process each of the main video data and the sub video data to generate the video data.

Next, embodiments are described.

### (1) First Embodiment

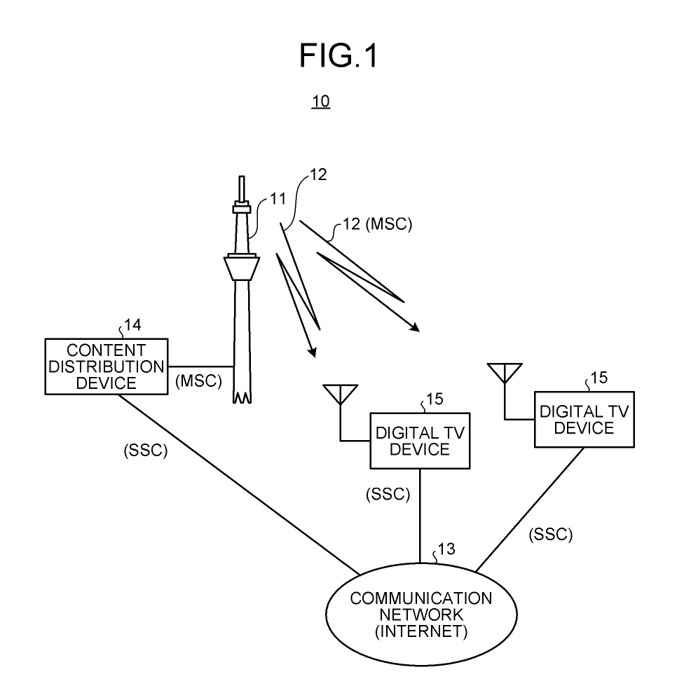

FIG. 1 is a schematic configuration block diagram illustrating a content distribution system according to this embodiment.

The following describes, as an example, a case where a 4K2K content, that is, a content having a quad full HD (QFHD) resolution (3840×2160) is distributed.

A content distribution system 10 comprises, when broadly divided, a content distribution device (broadcasting device) 14 and a plurality of digital television devices (digital TVs) 15. The content distribution device 14 distributes (a content of) a main stream MSC (2K1K resolution) over a broadcasting wave 12 through a broadcasting antenna 11 and distributes a sub stream content SSC (difference between the 4K2K content and the content MSC) through a communication network 13 such as the Internet. The digital television devices 15 function as content reproduction devices that receive (the contents of) the main streams MSC and (the contents of) the sub streams SSC to reproduce the contents.

Next, described is a configuration of the content distribution device 14.

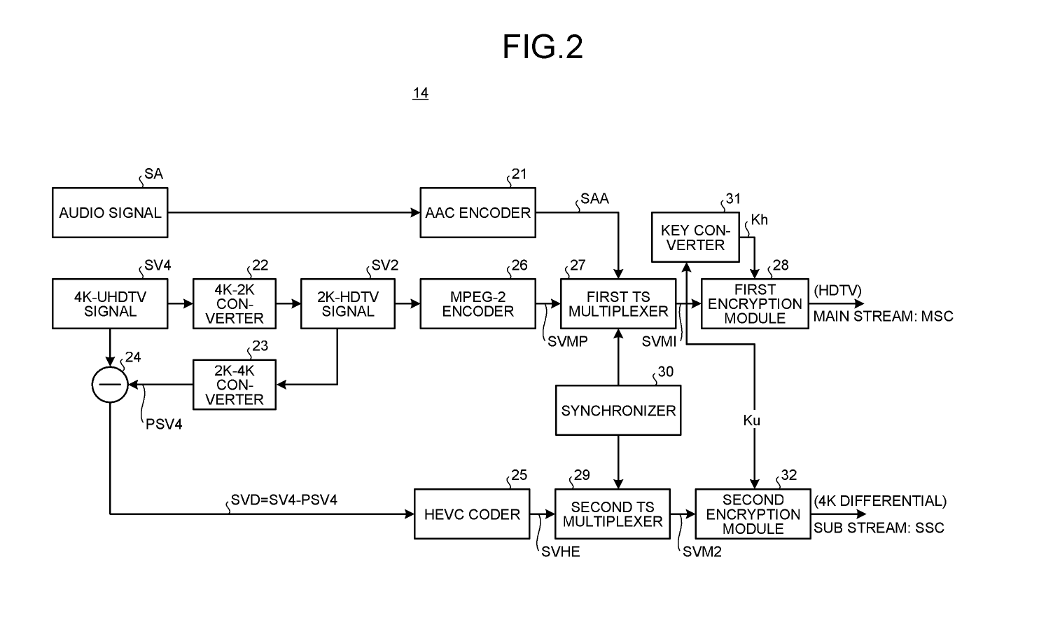

FIG. 2 is a schematic configuration block diagram illustrating the content distribution device.

The content distribution device 14 comprises an AAC encoder 21, a 4K-2K converter 22, a 2K-4K converter 23, and a subtractor 24. The AAC encoder 21 AAC-encodes an input audio signal SA and outputs an AAC-encoded signal SAA. The 4K-2K converter 22 4K-2K-converts an input 4K-UHDTV signal SV4 (4K2K resolution) SV4 and outputs a 2K-HDTV signal SV2 (whose resolution is 2K1K (1920 pixels×1080 pixels)) SV2. The 2K-4K converter 23 2K-4K-converts the 2K-HDTV signal SV2 input from the 4K-2K converter 22 and outputs a pseudo 4 KHDTV signal PSV4. The subtractor 24 extracts a difference between the 4K-UHDTV signal SV4 and the pseudo 4 KHDTV signal PSV4 and outputs a differential 4 KHDTV signal SVD.

Furthermore, the content distribution device 14 comprises an HEVC coder 25, an MPEG-2 encoder 26, a first TS multiplexer 27, a first encryption module 28, a second TS multiplexer 29, a synchronizer 30, a key converter 31, and a second encryption module 32. The HEVC coder 25 codes by high efficiency video coding (HEVC) the differential 4 KHDTV signal SVD input from the subtractor 24 and outputs an HEVC-coded signal SVHE. The MPEG-2 encoder 26 MPEG-2-encodes the 2K-HDTV signal SV2 input from the 4K-2K converter and outputs an MPEG-2-encoded signal SVMP. The first TS multiplexer 27 transport-stream (TS)-multiplexes the AAC-encoded signal and the MPEG-2-encoded signal SVMP and outputs the multiplexed signal as a first TS-multiplexed signal SVM1. The first encryption module 28 encrypts the first TS-multiplexed signal SVM1 with an input encryption key Kh and outputs the obtained signal as a main stream MSC. The second TS multiplexer 29 TS-multiplexes the HEVC-coded signal SVHE based on an encryption key Ku for encrypting the differential 4 KHDTV signal SVD and outputs a second TS-multiplexed signal SVM2. The synchronizer 30 synchronizes the first TS multiplexer 27 and the second TS multiplexer 29 to cause them to perform processing. The key converter 31 converts the encryption key Ku corresponding to 4K-2K content listening authority to an encryption key Kh corresponding to 2K-1K content listening authority with a one-way function such as a hash function (to be more specific, SHA-1 algorithm). The second encryption module 32 encrypts the second TS-multiplexed signal with the encryption key Ku and outputs the obtained signal as a 4K differential sub stream SSC.

Now, described is a schematic operation of the content distribution device 14.

The AAC encoder 21 of the content distribution device 14 AAC-encodes the input audio signal SA and outputs the AAC-encoded signal SAA to the first TS multiplexer 27.

The 4K-2K converter 22 4K-2K-converts the input 4K-UHDTV signal SV4 (4K2K resolution) SV4 and outputs the 2K-HDTV signal SV2 (whose resolution is 2K1K (1920 pixels×1080 pixels)) SV2 to the 2K-4K converter 23 and the MPEG-2 encoder 26.

The 2K-4K converter 23 2K-4K-converts the 2K-HDTV signal SV2 input from the 4K-2K converter 22 and outputs the pseudo 4 KHDTV PSV4 to the subtractor 24.

The subtractor 24 extracts a difference between the 4K-UHDTV signal SV4 and the pseudo 4 KHDTV signal PSV4 and outputs the differential 4 KHDTV signal SVD to the HEVC coder 25.

The MPEG-2 encoder 26 MPEG-2-encodes the 2K-HDTV signal SV2 input from the 4K-2K converter 22 and outputs the MPEG-2-encoded signal SVMP to the first TS multiplexer 27.

The first TS multiplexer 27 transport-stream (TS)-multiplexes the AAC-encoded signal SAA and the MPEG-2-encoded signal and outputs the obtained signal as the first TS-multiplexed signal SVM1 to the first encryption module 28.

The HEVC coder 25 HEVC-codes the differential 4 KHDTV signal input from the subtractor 24 and outputs the HEVC-coded signal SVHE to the second TS multiplexer 29.

The second TS multiplexer 29 TS-multiplexes, while being synchronized with the first TS multiplexer 27 by the synchronizer 30, the HEVC-coded signal SVHE based on the encryption key Ku for encrypting the differential 4 KHDTV signal SVD and outputs the second TS-multiplexed signal SVM2 to the second encryption module 32.

The key converter 31 converts the encryption key Ku corresponding to the 4K-2K content listening authority to the encryption key Kh corresponding to the 2K-1K content listening authority by the one-way function such as the hash function (to be more specific, SHA-1 algorithm), and outputs the encryption key Kh to the first encryption module 28.

As a result, the first encryption module 28 encrypts the first TS-multiplexed signal SVM1 with the input encryption key Kh and outputs the obtained signal as (the content of) the main stream MSC to a broadcasting device (not illustrated). Then, the broadcasting device distributes (the content of) the main stream MSC over the broadcasting wave 12 through the broadcasting antenna 11.

The second encryption module 32 encrypts the second TS-multiplexed signal SVM2 with the encryption key Ku and distributes the obtained signal as the 4K differential sub stream SSC through a communication interface device (not illustrated), such as a router, and the communication network 13.

Next, described is a configuration of the digital television device 15 as a content reproduction device.

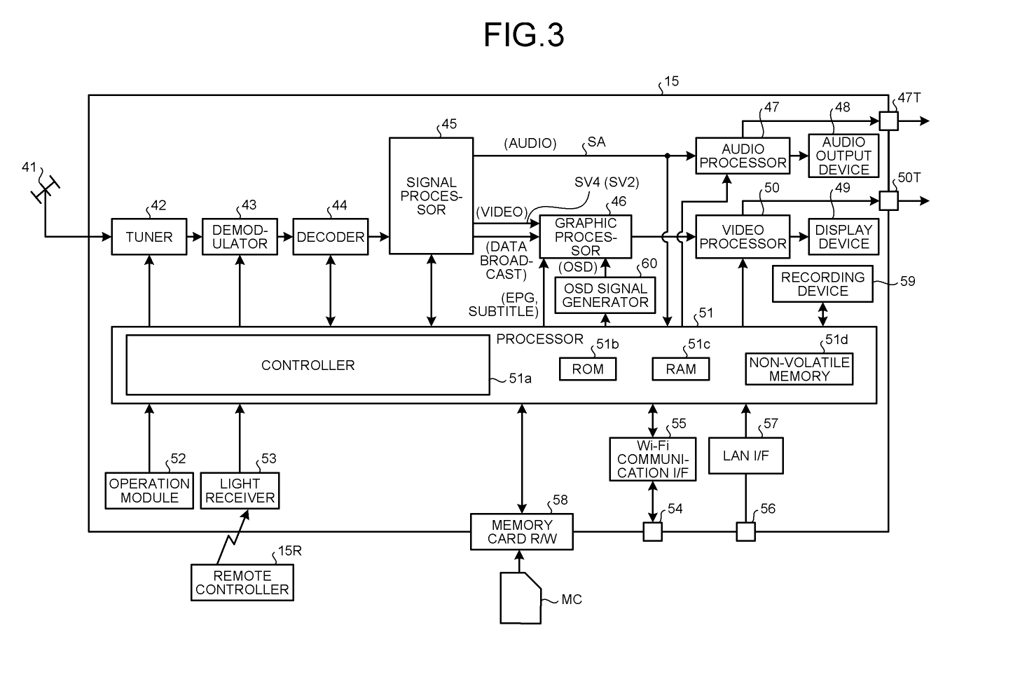

FIG. 3 is a schematic configuration block diagram illustrating the digital television device.

The digital television device 15 comprises a tuner 42, a demodulator 43, a decoder 44, and a signal processor 45, as illustrated in FIG. 3. The tuner 42 receives broadcast radio waves through an antenna 41 for receiving the broadcasting waves that is connected to an input side of the tuner 42. The demodulator 43 demodulates the broadcast signal received by the tuner 42 and extracts a transport stream. The decoder 44 decodes a transport stream broadcast signal demodulated by the demodulator 43. The signal processor 45 performs processing on an input signal.

Furthermore, the digital television device 15 comprises a graphic processor 46, an audio processor 47, an audio output device 48, and a video processor 50. The graphic processor 46 synthesizes a digital video signal to be supplied from the signal processor 45, an OSD signal, which will be described later, image data by data broadcast, and an EPG and a subtitle signal, which will be described later, and outputs a synthesized signal. The audio processor 47 converts a digital audio signal input from the signal processor 45 to an analog audio signal and outputs the analog audio signal. The audio output device 48 performs amplification and the like on the analog audio signal output from the audio processor 47 and outputs audio. The video processor 50 converts the digital video signal input from the signal processor 45 to an analog video signal that can be displayed on a display device 49 constituted by a liquid crystal display or the like, and thereafter, outputs the analog video signal to the display device 49 and causes the display device 49 to display a video on its display screen.

In addition, the digital television device 15 comprises a processor 51, an operation module 52, alight receiver 53, a Wi-Fi communication I/F 55, and a LAN I/F 57. The processor 51 controls the digital television device 15 overall. The operation module 52 allows a user to perform various types of operations. The light receiver 53 receives remote control light from an external remote controller 15R and outputs a remote control signal. The Wi-Fi communication I/F 55 is connected to a wireless communication network through a wireless LAN communication unit 54 and performs wireless communication. The LAN I/F 57 is connected to a communication network through a wired LAN terminal 56 and performs communication.

Moreover, the digital television device 15 comprises a memory card reader/writer (R/W) 58 and a recording device 59. The memory card reader/writer 58 reads various pieces of data from an IC memory card MC and writes various pieces of data into the IC memory card MC. The recording device 59 records the main stream content MSC received through the broadcast radio waves and the sub stream content SSC input through the Wi-Fi communication I/F 55 or the LAN I/F 57 as multiplexed streaming data obtained by TS-multiplexing them.

In the above-mentioned configuration, the processor 51 comprises a controller 51a, a read-only memory (ROM) 51b, a random access memory (RAM) 51c, and a non-volatile memory 51d. The ROM 51b stores control programs. The RAM 51c provides an operation area. The non-volatile memory 51d such as a flash memory stores therein various pieces of setting information, control information, program information, and the like in an updatable and non-volatile manner.

The controller 51a is constituted as a microprocessor. The controller 51a receives operation information from the operation module 52 or receives operation information transmitted from the remote controller 15R through the light receiver 53, and controls each component in a manner such that instructions in the operation information (for example, music information inquiry operation and channel switching operation) thereof are carried out.

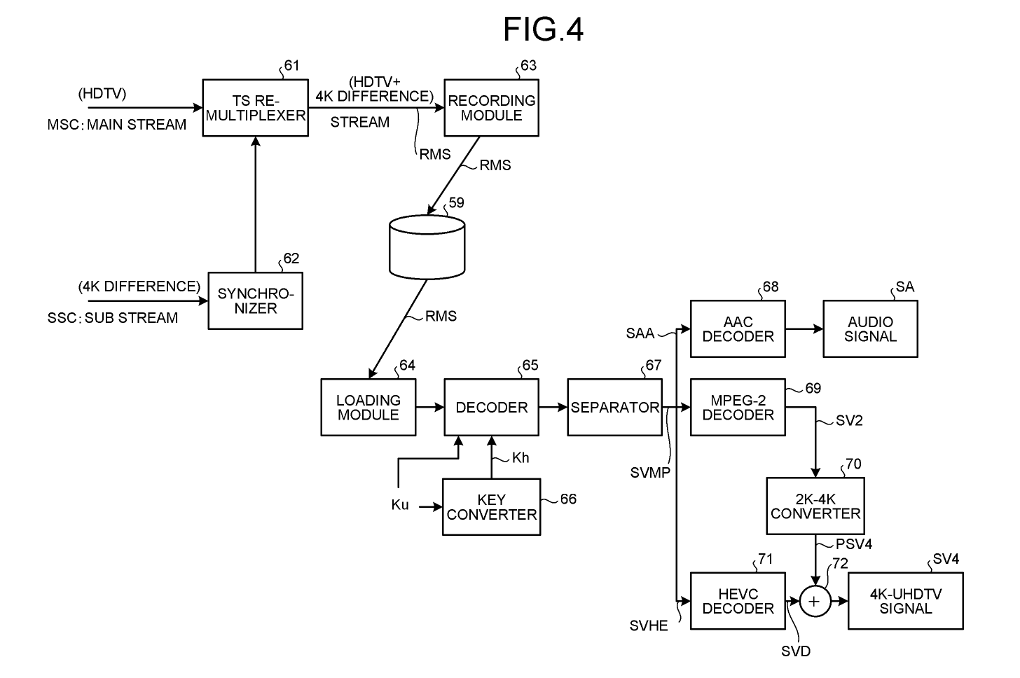

FIG. 4 is a schematic functional configuration block diagram illustrating the processor and the signal processor in the first embodiment.

In the following description, it is assumed that the main stream content MSC is input to the digital television device 15 over the broadcast radio waves and the sub stream content SSC is input to the digital television device 15 through the LAN I/F 57.

If the tuner 42 receives the broadcast radio waves through the antenna 41, the demodulator 43 demodulates the broadcast signal received by the tuner 42 to extract a transport stream.

Then, the decoder 44 decodes the transport stream broadcast signal demodulated by the demodulator 43 and outputs the main stream MSC to the signal processor 45 functioning as a TS re-multiplexer 61.

The LAN I/F 57 receives the sub stream SSC distributed through the communication network 13 such as the Internet and the wired LAN terminal 56, and outputs the sub stream SSC to the signal processor 45 functioning as a synchronizer 62.

The signal processor 45 as the synchronizer 62 synchronizes the sub stream SSC with the input main stream MSC, and as the TS re-multiplexer 61 re-multiplexes the sub stream SSC and the main stream MSC to generate a multiplexed stream RMS. Then, the signal processor 45 outputs the multiplexed stream RMS to the processor 51 functioning as a recording module 63.

The processor 51 functioning as the recording module 63 controls the recording device 59 to record the multiplexed stream RMS as a data stream of the content.

Thereafter, when the user directs reproduction of a data stream of the content recorded in the recording device 59, the processor 51 functions as a loading module 64 to load the multiplexed stream RMS as the corresponding content data stream and to output the multiplexed stream RMS to the signal processor 45 functioning as a decoder 65 and a key converter (key generator) 66.

The signal processor 45 first functions as the key converter 66 to convert the encryption key Ku corresponding to the 4K-2K content listening authority to the encryption key Kh corresponding to the 2K-1K content listening authority with a one-way function such as a hash function, and outputs the encryption key Kh to the signal processor 45 functioning as the decoder 65.

The signal processor 45 functioning as the decoder 65 decodes the multiplexed stream RMS based on the encryption key Ku and the encryption key Kh, and then functions as a separator 67.

The signal processor 45 functioning as the separator 67 separates the decoded multiplexed stream RMS into an AAC-encoded signal SAA, an MPEG-2-encoded signal SVMP, and an HEVC-coded signal SVHE.

Subsequently, the signal processor 45 functioning as an AAC decoder 68 decodes the input AAC-encoded signal SAA and outputs it as an audio signal SA to the audio processor 47.

The audio processor 47 converts the digital audio signal SA input from the signal processor 45 to an analog audio signal and outputs it to the audio output device 48 and an audio output terminal 47T. The audio output device 48 performs amplification and the like on the analog audio signal output from the audio processor 47 and outputs audio.

The signal processor 45 functioning as an MPEG-2 decoder 69 decodes the input MPEG-2-encoded signal SVMP to generate a 2K-HDTV signal SV2. The signal processor 45 then functions as a 2K-4K converter 70.

The signal processor 45 functioning as the 2K-4K converter 70 performs 2K-4K conversion (up conversion) on the input 2K-HDTV signal SV2 and outputs a pseudo 4 KHDTV signal PSV4. Furthermore, the signal processor 45 functioning as an HEVC decoder 71 decodes the input HEVC-coded signal SVHE and outputs a differential 4 KHDTV signal SVD.

As a result, the signal processor 45 functioning as a synthesizer 72 synthesizes (adds) the pseudo 4 KHDTV signal PSV4 and the differential 4 KHDTV signal SVD, and outputs a 4K-UHDTV signal SV4 as a digital video signal to the graphic processor 46.

The graphic processor 46 synthesizes the 4K-UHDTV signal SV4 as the digital video signal supplied from the signal processor 45, image data by data broadcast, and the EPG and the subtitle signal that has been input from the OSD signal generator 59 and supplied from the OSD signal generator 60, and outputs the synthesized signal to the video processor 50.

The video processor 50 converts the digital video signal input from the signal processor 45 to an analog video signal that can be displayed on the display device 49 constituted by a liquid crystal display or the like. After that, the video processor 50 outputs the analog video signal to the display device 49 and a video output terminal 50T so as to display a video on the display screen of the display device 49 or on the display screen of an external display device (not illustrated) connected to the video output terminal 50T. It is to be noted that an external recording device such as a recorder can be connected to the video output terminal 50T.

As a result, the digital television device 15 reproduces a content (4K-UHDTV content) having a 4K2K resolution that has been distributed by the content distribution device 14.

4K-UHDTV contents that can be generated by synthesizing the main stream MSC and the sub stream SSC have a high resolution and exhibit high realistic sensation. The 4K-UHDTV contents are therefore premium contents in comparison with contents of normal HDTV image quality. The user can obtain 4K-UHDTV contents by paying an additional charge or signing a contract for viewing the 4K-UHDTV contents.

In the embodiment, a user with access to contents of the normal HDTV image quality only is not allowed to reproduce (generate) the 4K-UHDTV contents. An apparatus (in the above description, the digital television device 15) of a user with a contract for viewing the 4K-UHDTV contents with a content provider can obtain the encryption key Ku, from which the user can obtain the content key Kh for viewing the contents of the HDTV image quality (2K1K).

In this case, when a content having the 2K1K resolution is reproduced, the 2K-HDTV signal SV2 output from the signal processor 45 functioning as the MPEG-2 decoder 69 is output to the graphic processor 46 as it is so as to be reproduced.

On the other hand, an apparatus of a user with a contract with the content provider for viewing only normal HDTV contents but not 4K-UHDTV contents can obtain the encryption key Kh. However, the apparatus cannot obtain the content key Ku for viewing the contents of 4K-UHDTV image quality or obtain it from the content key Kh by calculation because of the one-way function used for generating the key as described above.

According to the first embodiment, as described above, a key to be used in encryption processing on the data stream corresponding to the 2K1K resolution (second resolution) that is lower than the 4K2K resolution (first resolution) is generated from a data stream of the content corresponding to the 4K2K resolution (first resolution) based on the data stream recorded in the recording device (recording module) 59. The key generation can be performed by using the key (key Kh) that is generated from the key (key Ku) used in the encryption processing on the data stream having the 4K2K resolution by using the one-way function. Thus, when both the 4K2K content and the 2K1K content are recorded in the recording device 59, they are multiplexed so as to be recorded as a single content. This keeps recorded volume from increasing.

In addition, as described above, encryption keys (in the above-mentioned example, key Ku and key Kh) that correspond to a plurality of contents having different resolutions and corresponding to the same content are not mutually independent but are mutually related. Thus, usability for the user is not degraded.

### (2) Second Embodiment

The above first embodiment describes cases of reproducing the content having the 4K2K resolution and the content having the 2K1K resolution. The second embodiment is, however, an embodiment for generating data streams of contents having lower resolutions.

Hereinafter, description is made for cases of generating a data stream for a standard definition television (SDTV) (standard image quality, for example, 720 pixels×480 pixels) and a data stream for a mobile machine having a resolution lower than that of the SDTV (for example, VGA: 640 pixels×480 pixels).

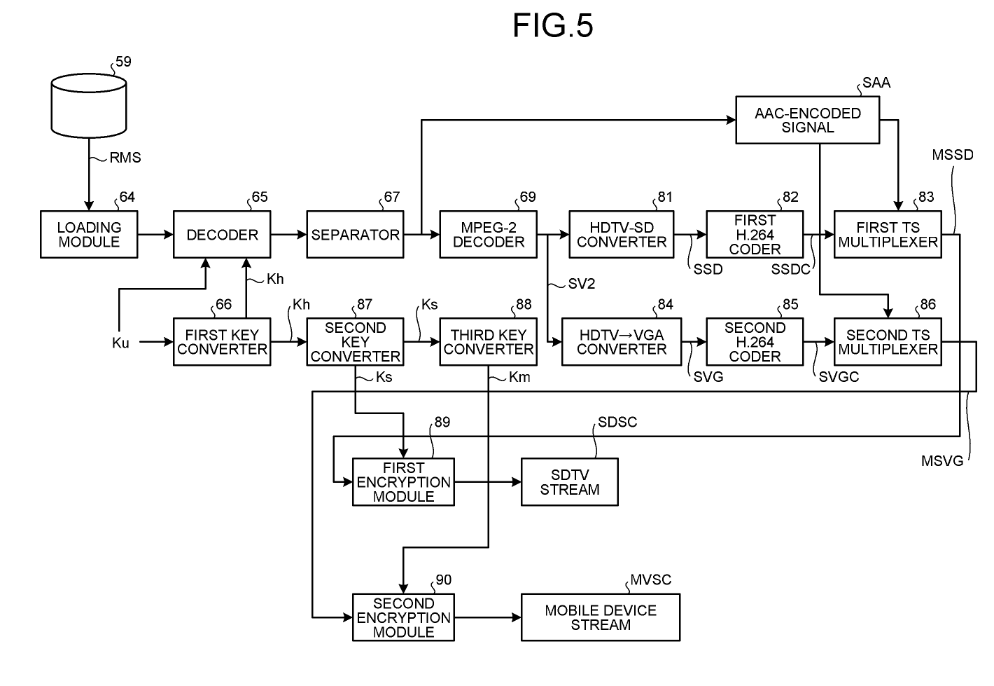

FIG. 5 is a schematic functional configuration block diagram illustrating a processor and a signal processor in the second embodiment.

In FIG. 5, the same reference numerals denote the same components as those in the first embodiment as illustrated in FIG. 4.

Also in the following description, it is assumed that the main stream content MSC is input to the digital television device 15 over the broadcast radio waves and the sub stream content SSC is input to the digital television device 15 through the LAN I/F 57.

As in the first embodiment, when the user directs reproduction of a data stream of the content recorded in the recording device 59, the processor 51 functions as the loading module 64 to load a multiplexed stream RMS as a corresponding content data stream and to output the multiplexed stream RMS to the signal processor 45 functioning as the decoder 65 and the key converter (key generator) 66.

The signal processor 45 first functions as the key converter 66 to convert the encryption key Ku corresponding to the 4K-2K content listening authority to the encryption key Kh corresponding to the 2K-1K content listening authority with the one-way function such as the hash function, and outputs the encryption key Kh to the signal processor 45 functioning as the decoder 65.

The signal processor 45 functioning as the decoder 65 decodes the multiplexed stream RMS based on the encryption key Ku and the encryption key Kh, and then functions as the separator 67.

The signal processor 45 functioning as the separator 67 separates the decoded multiplexed stream RMS into an AAC-encoded signal SAA and an MPEG-2-encoded signal SVMP.

Then, the signal processor 45 functioning as the MPEG-2 decoder 69 decodes the input MPEG-2-encoded signal SVMP to generate a 2K-HDTV signal SV2, and outputs it to an HDTV-SD converter 81 and an HDTV-VGA converter 84.

The signal processor 45 functions as the first key converter 66 having the same configuration as the key converter 66 in the first embodiment. The signal processor 45 converts the encryption key Ku corresponding to the 4K-2K content listening authority to the encryption key Kh corresponding to the 2K-1K content listening authority with the one-way function such as the hash function, and outputs the encryption key Kh to the signal processor 45 functioning as the decoder 65 and a second key converter 87 that generates an encryption key Ks that is used for generating a data stream for the SDTV.

The signal processor 45 functioning as the second key converter 87 converts the encryption key Kh corresponding to the 2K-1K content listening authority to the encryption key Ks corresponding SDTV content listening authority with the one-way function such as the hash function, and outputs the encryption key Ks to a third key converter 88 and a first encryption module 89. The third key converter 88 generates an encryption key Km that is used for generating a data stream for the mobile machine. The first encryption module 89 encrypts the data stream of the SDTV content.

Then, the signal processor 45 functioning as the third key converter 88 generates the encryption key Km that is used for generating the data stream for the mobile machine from the encryption key Ks corresponding to the SDTV content listening authority with the one-way function such as the hash function, and outputs the encryption key Km to a second encryption module 90 that encrypts the data stream of contents for the mobile machine.

The HDTV-SD converter 81 converts the resolution of the input 2K-HDTV signal SV2 to generate an SDTV signal SSD and outputs it to a first H.264 coder 82.

The first H.264 coder 82 performs compression coding on the SDTV signal SSD in accordance with H.264-compliant compression coding to generate a compression-coded SDTV signal SSDC and outputs it to a first TS multiplexer 83.

The first TS multiplexer 83 multiplexes the AAC-encoded signal SAA input from the separator 67 and the compression-coded SDTV signal SSDC to generate a multiplexed SDTV signal MSSD and outputs it to the first encryption module 89.

The first encryption module 89 encrypts the multiplexed SDTV signal MSSD by using the encryption key Ks output from the second key converter 87 to generate an SDTV data stream SDSC and outputs it.

In the same manner, the HDTV-VGA converter 84 converts the resolution of the input 2K-HDTV signal SV2 to generate a VGATV signal SVG for the mobile machine and outputs it to a second H.264 coder 85.

The second H.264 coder 85 performs compression coding on the VGATV signal SVG in accordance with H.264-compliant compression coding to generate a compression-coded VGATV signal SVGC and outputs it to a second TS multiplexer 86.

The second TS multiplexer 86 multiplexes the AAC-encoded signal SAA input from the separator 67 and the compression-coded VGATV signal SVGC to generate a multiplexed VGATV signal MSVG and outputs it to the second encryption module 90.

The second encryption module 90 encrypts the multiplexed VGATV signal MSVG by using the encryption key Km output from the third key converter 88 to generate an SVGA data stream MVSC for the mobile machine and outputs it.

As described above, according to the second embodiment, a key to be used in encryption processing on the data stream corresponding to an SDTV resolution that is lower than the 4K2K resolution (first resolution) and a VGA resolution that is further lower is generated from a data stream of the content corresponding to the 4K2K resolution (first resolution) based on the data stream recorded in the recording device (recording module) 59. The key generation can be performed by using the keys (key Kh, key Ks, key Km) that are generated from the key (key Ku) used in the encryption processing on the data stream having the 4K2K resolution by using the one-way function in a multistep manner. The encryption keys (key Ku, key Kh, key Ks, and key Km) that correspond to a plurality of contents having different resolutions and corresponding to the same content are therefore not mutually independent but are mutually related. Thus, usability for the user is not degraded.

### (3) Modifications of Embodiments

While a timing of receiving the main stream MSC and the sub stream SSC has not been described in detail in the above description, the above-mentioned system can be applied to any of the following: when the digital television device 15 as the receiver receives the main stream and the sub stream simultaneously, when the digital television device 15 receives the sub stream after receiving the main stream, and when the digital television device 15 receives the main stream after receiving the sub stream.

For example, programmed reception of the sub stream can be performed by previously specifying a program that the user wants to view by using an electronic program guide (EPG) and programming a server at a broadcast station to transmit the sub stream before the main stream starts to be broadcast.

In this case, because the sub stream has been received previously, a content of HDTV image quality can be up-converted to a content of 4K2K image quality simultaneously with reception of the main stream, for example.

In a case where the sub stream cannot be acquired previously, such as a case of broadcasting the main stream live, the sub stream can be programmed to be received once the main stream has started to be broadcast.

In this case, for example, the sub stream is synthesized with the main stream at the time of reception of the sub stream and the obtained stream is up-converted to a content of 4K2K image quality, so that the main stream is stored temporarily.

Furthermore, both the main stream MSC and the sub stream SSC can be configured to be recorded and reproduced after recording.

Next, described is a case where both the main stream MSC and the sub stream SSC are recorded.

It may be assumed that the receiver does not necessarily simultaneously receive the HDTV main stream and the 4K differential sub stream as described above, but at different timings.

When both the HDTV main stream and the 4K differential sub stream are held in the digital television device 15 (recording device 59) as the receiver, they are re-multiplexed by MPEG-2 TS. As described above, as synchronization information between two streams, an absolute time of the main stream at a head image of the sub stream is delivered at the resolution of PTS (not illustrated). Based on the synchronization information, re-multiplexing is performed, and the PTS is replaced if necessary.

In this scheme, multiplexing is performed without generating contents of 4K-UHDTV image quality (without decoding, synthesizing, re-coding, and re-encrypting each of the main stream and the sub stream), which results in an extremely light processing load. Furthermore, re-synchronization processing is previously performed on a main frame and a sub frame at the time of recording, which leads to an advantage that re-synchronization processing is unnecessary at the time of reproduction. Furthermore, if a re-multiplexed HDTV+4K differential stream on which the re-synchronization processing has been performed is recorded and stored in the recording device 59 constituted as a hard disk drive, for example, reproduction can be performed in accordance with the above-mentioned procedures.

While synchronization of the main stream MSC and the sub stream SSC is not described in detail above, the synchronization can be performed in accordance with a presentation time stamp (PTS) of a head image or an audio frame of the sub stream specified with a corresponding time in an absolute time (date, time (down to ms unit)) of the mainstream (not illustrated). In this case, temporal resolutions of the PTS of the main stream MSC and the sub stream SSC are supposed to be identical.

In the above description, generation of the keys to be used in the encryption processing has not been described. The encryption keys Ku and Kh may be the same encryption keys in a channel, may be fixed encryption keys for each content/program, or may be encryption keys that change with time (for example, every minute). As a distribution method of the encryption keys, CAS distribution or key distribution with mutual authentication between a key distribution server and a receiver may be employed.

In the embodiment, for example, the controller 51 of the digital television device 15 acquires the encryption key Ku from a CAS card or a key distribution server and performs the above-mentioned processing by using the acquired encryption key Ku. The digital television device 15 can therefore perform the above-mentioned processing without acquiring the encryption key Kh from the outside.

In the above description, a differential data stream as the sub stream SSC is obtained as a difference between the 4K2K content and the HDTV content (2K1K content). However, the differential data stream may be obtained from combinations of contents with other resolutions such as an 8K4K content and an HDTV content (2K1K content), an 8K4K content and a 4K2K content, and a 4K2K content and an SDTV content.

In the above description, the digital television device 15 has been described as an information processing device, as an example. The information processing device can, however, be a set top box or a digital recorder.

Control programs to be executed in the information processing device (in the embodiment, digital television device 15) in the embodiment are recorded and provided in a computer-readable recording medium such as a compact disc read-only memory (CD-ROM), a flexible disk (FD), a CD recordable (CD-R), or a digital versatile disk (DVD), in an installable or executable format.

Furthermore, the control programs to be executed in the information processing device in the embodiment may be configured to be provided by being stored on a computer connected to a network such as the Internet and being downloaded through the network. Alternatively, the control programs to be executed in the information processing device in the embodiment may be configured to be provided or distributed through a network such as the Internet.

The control programs to be executed in the information processing device in the embodiment may be configured to be provided by being previously incorporated in a read-only memory (ROM) or the like.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing device comprising:
an input module configured to receive encrypted main video data comprising down-converted video data of video data corresponding to an initial resolution of a content, and to receive encrypted sub video data comprising difference data between high-resolution video data obtained by up-converting the main video data and the video data corresponding to the initial resolution;
a key acquisition module configured to acquire a first encryption key corresponding to the encrypted sub video data;
a key generator configured to generate a second encryption key corresponding to the encrypted main video data from the first encryption key by using a one-way function;
a decoder configured to decode the encrypted sub video data by using the first encryption key and to decode the encrypted main video data by using the second encryption key; and
an initial resolution video generator configured to process each of the main video data and the sub video data to generate the video data.

2. The information processing device of claim 1, wherein the input module is configured to receive multiplexed data comprising the encrypted main video data and the encrypted sub video data that are multiplexed from a recording device configured to record the multiplexed data,
the decoder is configured to decode the encrypted sub video data and the encrypted main video data contained in the multiplexed data by using the first encryption key and the second encryption key,
the information processing device further comprises a separator configured to separate the main video data and the sub video data that are obtained from the multiplexed data, and
the initial resolution video generator is configured to process the main video data and the sub video data.

3. The information processing device of claim 2, further comprising:
a multiplexer configured to receive the encrypted main video data and the encrypted sub video data to generate the multiplexed data comprising the encrypted main video data and the encrypted sub video data that are multiplexed, and
a recording module configured to record the multiplexed data in the recording device.

4. The information processing device of claim 2, further comprising:
a down converter configured to generate second main video data by down-converting the main video data; and
an encryption module configured to encrypt the second main video data, wherein
the key generator is configured to generate a third encryption key corresponding to the second main video data from the second encryption key by using a one-way function, and
the encryption module is configured to encrypt the second main video data by using the third encryption key.

5. The information processing device of claim 1, wherein the input module is configured to receive a data stream containing the encrypted main video data and audio data and to receive a data stream containing the sub video data and no audio video data.

6. An information processing control method comprising:
receiving encrypted main video data comprising down-converted video data of video date corresponding to an initial resolution of a content, and receiving encrypted sub video data difference data between high-resolution video data obtained by up-converting the main video data and the video data corresponding to the initial resolution;
acquiring a first encryption key corresponding to the encrypted sub video data;
generating a second encryption key corresponding to the encrypted main video data from the first encryption key by using a one-way function;
decoding the encrypted sub video data by using the first encryption key and decoding the encrypted main video data by using the second encryption key; and
processing each of the main video data and the sub video data to generate the video data corresponding to the initial resolution of the content.

7. A computer program product comprising a non-transitory computer readable medium comprising programmed instructions, wherein the instructions, when executed by a computer, cause the computer to perform:
receiving encrypted main video data comprising down-converted video data of video data corresponding to an initial resolution of a content, and receiving encrypted sub video data comprising difference data between high-resolution video data obtained by up-converting the main video data and the video data corresponding to the initial resolution;
acquiring a first encryption key corresponding to the encrypted sub video data;
generating a second encryption key corresponding to the encrypted main video data from the first encryption key by using a one-way function;
decoding the encrypted sub video data by using the first encryption key and decoding the encrypted main video data by using the second encryption key; and
processing each of the main video data and the sub video data to generate the video data corresponding to the initial resolution of the content.
